(19) United States
(12) Patent Application Publication
(10) Pub. No.: US 2023/0337694 A1
(43) Pub. Date: Oct. 26, 2023

(54) FAT COMPOSITION

(71) Applicants: Bunge Loders Croklaan B.V., Wormerveer (NL); Bunge Lipid Enzymtec Sdn. Bhd., Pasir Gudang, Johor (MY); Bunge Loders (Xiamen) Oils Technology Co., Ltd., Xiamen, Fujian (CN)

(72) Inventors: Kim Leong CHUA, Pasir Gudang, Johor (MY); You Chun YAN, Xiamen, Fujian (CN); Jun MA, Wormerveer (NL); Sze Hui NG, Pasir Gudang, Johor (NL); Suharulpazillah CHE NORDIN, Pasir Gudang, Johor (MY)

(21) Appl. No.: 18/004,970

(22) PCT Filed: Jul. 9, 2021
(86) PCT No.: PCT/EP2021/069158

§ 371 Date: Jan. 10, 2023

(30) Foreign Application Priority Data
Jul. 10, 2020 (WO) PCT/CN2020/101183

(51) Int. Cl. A23D 9/007; A23L 33/00; A23L 33/115; A23D 9/04

(52) U.S. Cl. CPC A23D 9/007; A23L 33/40; A23L 33/115; A23D 9/04

(57) ABSTRACT

The invention provides a fat composition comprising from 20% to 50% by weight of palmitic acid (C16:0), from 20% to 45% by weight of oleic acid (C18:1), and from 17% to 40% by weight of linoleic acid (C18:2), said percentages of acid being based on the total weight of C8 to C24 fatty acids; wherein the fat composition has a weight ratio of oleic acid (C18:1) to linoleic acid (C18:2) of from 0.4 to 2.4; wherein the percentage of palmitic acid on the second position of triglyceride (SN-2 of C16:0) is at least 40% based on the total amount of palmitic acid; and wherein the fat composition comprises at most 5.0% by weight of PPP triglycerides and has a weight ratio of OPL triglycerides to OPO triglycerides from 0.80 to 1.60 based on the total glycerides present in the fat composition, wherein O is oleic acid, P is palmitic acid and L is linoleic acid.

This invention relates to a fat composition, a substitute human milk fat blend, an infant formula, use of the fat composition, use of the substitute human milk fat blend, a process of making the fat composition, a process of preparing a substitute human milk fat blend and a process of preparing an infant formula.

### BACKGROUND

Fats and oils are important ingredients of food products and used extensively in the food industry. Fat compositions containing similar amounts of the principal fatty acids found in human milk fat may be derived from oils and fats of vegetable origin. However, there remains a significant difference in composition between vegetable oils or fats and human milk fat.

Certain triglycerides are nutritionally important, for example, the triglyceride 1,3-dioleoyl-2-palmitoylglycerol (OPO) and the triglyceride 1-oleoyl-2-palmitoyl-3-linoleoylglycerol (OPL), which are known to be important components of human milk fat. These triglycerides are believed to have important dietary consequences, in particular when these triglycerides are balanced in the composition. In order to obtain these triglycerides which closely match the chemical and/or physical properties of those of human milk fat, it is necessary to control the distribution of the fatty acid residues on the glyceride positions.

EP-A-3 583 857 relates to a process for producing a composition comprising 1,3-dioleoyl-2-palmitoyl glyceride (OPO), a composition comprising 1,3-dioleoyl-2-palmitoyl glyceride prepared by that process, and a baby food.

X. Wang et al., LWT—Food Science and Technology, Volume 118, January 2020, Article 108798 is directed to enzymatic synthesis of structured triacylglycerols rich in 1,3-dioleoyl-2-palmitoylglycerol and 1-oleoyl-2-palmitoyl-3-linoleoylglycerol in a solvent free system.

EP-A-0209327 describes substitute milk fat especially as a replacement fat in infant formulations comprises 2-saturated glycerides, particularly 2-palmitic acid glycerides, in which the 1,3 positions are randomly occupied substantially by different shorter chain and/or unsaturated fatty acids. The glycerides are prepared by selective rearrangement of glycerides using 1,3-regio-specific lipase enzymes as rearrangement catalysts, preferably in acidolysis rearrangement using an unsaturated acid or alkyl ester thereof.

EP-A-0496456 relates to fat compositions that resemble human milk fat comprising triglycerides in which at least 40 wt. % of the total amount of saturated fatty acid residues present in the triglycerides are bonded at the 2-position. The fatty acid residues in 1- and 3-positions are randomly or non-randomly distributed between these positions and include oleic, linoleic and linolenic acid and other unsaturated residues.

WO 2008/104381 describes a process for the production of a composition comprising 1,3-dioleoyl-2-palmitoyl glyceride (OPO) which comprises: providing one or more palm oil stearin fractions comprising tripalmitoyl glyceride and having an iodine value between about 18 and about 40; interesterifying the one or more palm oil stearin fractions to form a randomly interesterified palm oil stearin; subjecting the randomly interesterified palm oil stearin to enzymic transesterification with oleic acid or a non-glyceride ester thereof using an enzyme having selectivity for the 1- and 3-positions of a glyceride; and separating palmitic acid or palmitic non-glyceride esters from the product obtained in (iii) to form a composition comprising OPO glyceride.

WO 2015/177042 is directed to a process for immobilizing a lipase on a support containing a functional amino group, which comprises contacting the lipase with said support in the presence of a surface-active material.

WO 2005/036987 describes fat compositions which are components in the preparation of fat blends and infant formulas, as well as a process of producing the same.

WO 2006/114791 relates to human milk fat (HMF) substitutes, processes for their preparation, uses thereof and fat blends and infant formulae containing them.

Shi-Ying Li et al., International Journal of Child Health and Nutrition, 2015, 4, 230-239 relates to long-chain polyunsaturated fatty acid concentrations in breast milk from Chinese mothers and comparison with other regions.

There remains a need for an improved fat composition for use in infant formula, preferably a fat composition with an enhanced oxidative stability, a high SN-2 level of palmitic acid (to mimic human milk fat) with balanced levels of OPO triglycerides and OPL triglycerides, and of oleic acid and linoleic acid content and that, when used in infant formula, can relieve constipation by reducing the calcium soap in infant stools.

### DESCRIPTION OF THE INVENTION

According to the present invention, there is provided a fat composition, comprising: from 20% to 50% by weight of palmitic acid (C16:0), from 20% to 45% by weight of oleic acid (C18:1), and from 17% to 40% by weight of linoleic acid (C18:2) and having a weight ratio of oleic acid (C18:1) to linoleic acid (C18:2) of from 0.4 to 2.4, said percentages of acid being based on the total weight of C8 to C24 fatty acids. The fat composition has a percentage of palmitic acid on the second position of triglyceride out of total palmitic acid (SN-2 of C16:0) at least 40%. The fat composition comprises at most 5.0% by weight of PPP triglycerides and has a weight ratio of OPL triglycerides to OPO triglycerides of from 0.80 to 1.60, based on the total glycerides present in the fat composition, wherein O is oleic acid, P is palmitic acid and L is linoleic acid.

The fat composition of the invention has been found to be particularly suitable for use in a substitute milk fat blend and, further, in an infant formula. This is believed to be at least in part due to its balanced level of oleic acid and linoleic acid, not only in terms of fatty acid composition, but also in form of OPO triglycerides and OPL triglycerides. These features are particularly important nutritionally. The fat composition of the invention surprisingly has also improved oxidative stability and a reduced aldehyde level after refining which is particularly advantageous for use in infant formula. Furthermore, the fat composition of the invention is close to human milk fat in terms of low PPP triglycerides, which is beneficial on relieving constipation by reducing the calcium soap in infant stools, and in terms of high SN-2 value of palmitic acid. In addition, it is particularly convenient to prepare a substitute human milk fat from the fat composition according to the invention. The present inventors have surprisingly found that the process for producing a substitute human milk fat based on the fat composition according to the invention is less complex and more efficient. It is believed that one of the reasons for this is that the fat composition of the invention has a fatty acid composition which is similar to the substitute human milk fat.

The term “fat” refers to glyceride fats and oils containing fatty acid acyl groups and does not imply any particular melting point. The term “oil” is used synonymously with “fat”.

The term “fatty acid” refers to straight chain saturated or unsaturated (including mono- and poly unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1. The fatty acid profile may be determined by fatty acid methyl ester analysis (FAME) using gas chromatography according to ISO 12966-2 and ISO 12966-4. The equivalent method may be used according to AOCS Ce 2-66 and AOCS Ce 1a-13. Thus, unless otherwise specified, percentages of fatty acids in compositions (e.g. palmitic acid (C16:0), stearic acid (C18:0), oleic acid (C18:1) etc.) referred to herein include both acyl groups such as tri-, di- and mono-glycerides and free fatty acids and are based on the total weight of C8 to C24 fatty acid residues.

The term “triglyceride” refers to glycerides consisting of three fatty acid chains covalently bonded to a glycerol molecule. Amounts of triglycerides defined herein, unless otherwise specified, are percentages by weight based on total triglycerides present in the fat composition. The notation triglyceride XYZ denotes triglycerides having fatty acid acyl groups X, Y and Z at any of the 1-, 2- and 3-positions of the glyceride. The notation A2B includes both AAB and ABA, and AB2 includes both ABB and BAB. Triglyceride content may be determined for example by GC (ISO 23275).

The fat composition according to the invention may be made from naturally occurring or synthetic fats, fractions of naturally occurring or synthetic fats, or mixtures thereof, that satisfy the requirements defined herein. Preferably, the fat composition is, or is derived from, one or more vegetable fats or animal fats. More preferably, the fat composition is, or is derived from, one or more vegetable fats. It is also preferred that the fat composition according to the invention is, or is derived from, one or more non-hydrogenated fats. The term “non-hydrogenated” means that the fat composition is not prepared from a fat that has been subjected to hydrogenation to convert unsaturated fatty acyl groups to saturated fatty acyl groups.

The fat composition of the invention preferably has a weight ratio of oleic acid (C18:1) to linoleic acid (C18:2) of from 0.6 to 2.2, more preferably from 0.8 to 2.0, even more preferably from 0.9 to 1.8 and most preferably from 1.0 to 1.7.

The fat composition according to the invention preferably comprises at most 5% by weight of lauric acid (C12:0), more preferably from 0% to 4% by weight, even more preferably from 0% to 3% by weight and most preferably from 0% to 2% by weight; said percentage of acid being based on the total weight of C8 to C24 fatty acids.

The fat composition according to the invention preferably comprises from 23% to 48% by weight of palmitic acid (C16:0), more preferably from 25% to 45% by weight, even more preferably from 28% to 43% by weight and most preferably from 30% to 40% by weight; said percentage of acid being based on the total weight of C8 to C24 fatty acids.

The fat composition according to the invention preferably comprises from 22% to 45% by weight of oleic acid (C18:1), more preferably from 25% to 43% by weight, even more preferably from 27% to 41% by weight and most preferably from 28% to 41% by weight; said percentage of acid being based on the total weight of C8 to C24 fatty acids.

The fat composition according to the invention preferably comprises from 18% to 38% by weight of linoleic acid (C18:2), more preferably from 19% to 35% by weight, even more preferably from 20% to 32% by weight and most preferably from 20% to 30% by weight; said percentage of acid being based on the total weight of C8 to C24 fatty acids.

The fat composition according to the invention preferably comprises at most 5% by weight of linolenic acid (C18:3), more preferably from 0% to 4% by weight, even more preferably from 0% to 3.5% by weight and most preferably from 0% to 3% by weight; said percentage of acid being based on the total weight of C8 to C24 fatty acids.

The fat composition according to the invention preferably has a percentage of palmitic acid on the second position of triglyceride out of total palmitic acid (SN-2 of C16:0) at least 45%, more preferably from 50% to 80%, even more preferably from 55% to 75% and most preferably from 60% to 70%.

Accordingly, in a preferred embodiment, the fat composition according to the invention comprises at most 5% by weight of lauric acid (C12:0); from 23% to 48% by weight of palmitic acid (C16:0); from 22% to 45% by weight of oleic acid (C18:1); from 18% to 38% by weight of linoleic acid (C18:2); and at most 5% by weight of linolenic acid (C18:3); and has a weight ratio of oleic acid (C18:1) to linoleic acid (C18:2) of from 0.6 to 2.2; said percentages of acid being based on the total weight of C8 to C24 fatty acids; and a percentage of palmitic acid on the second position of triglyceride out of total palmitic acid (SN-2 of C16:0) at least 45%.

In a more preferred embodiment, the fat composition according to the invention comprises from 0% to 4% by weight of lauric acid (C12:0); from 25% to 45% by weight of palmitic acid (C16:0); from 25% to 43% by weight of oleic acid (C18:1); from 19% to 35% by weight of linoleic acid (C18:2); and from 0% to 4% by weight of linolenic acid (C18:3); and has a weight ratio of oleic acid (C18:1) to linoleic acid (C18:2) of from 0.8 to 2.0; said percentages of acid being based on the total weight of C8 to C24 fatty acids; and a percentage of palmitic acid on the second position of triglyceride out of total palmitic acid (SN-2 of C16:0) from 50% to 80%.

In an even more preferred embodiment, the fat composition according to the invention comprises from 0% to 3% by weight of lauric acid (C12:0); from 28% to 43% by weight of palmitic acid (C16:0); from 27% to 41% by weight of oleic acid (C18:1); from 20% to 32% by weight of linoleic acid (C18:2); and from 0% to 3.5% by weight of linolenic acid (C18:3); and has a weight ratio of oleic acid (C18:1) to linoleic acid (C18:2) of from 0.9 to 1.8; said percentages of acid being based on the total weight of C8 to C24 fatty acids; and a percentage of palmitic acid on the second position of triglyceride out of total palmitic acid (SN-2 of C16:0) from 55% to 75%.

In a most preferred embodiment, the fat composition according to the invention comprises from 0% to 2% by weight of lauric acid (C12:0); from 30% to 40% by weight of palmitic acid (C16:0); from 28% to 41% by weight of oleic acid (C18:1); from 20% to 30% by weight of linoleic acid (C18:2); and from 0% to 3% by weight of linolenic acid (C18:3); and has a weight ratio of oleic acid (C18:1) to linoleic acid (C18:2) of from 1.0 to 1.7; said percentages of acid being based on the total weight of C8 to C24 fatty acids; and a percentage of palmitic acid on the second position of triglyceride out of total palmitic acid (SN-2 of C16:0) from 60% to 70%.

The fat composition according to the invention preferably has an iodine value of from 55 to 90, more preferably from 60 to 85, even more preferably from 65 to 83 and most preferably from 68 to 81. The term “iodine value” refers to the number of grams of iodine that could be taken up by 100 g of oil. Iodine value may be calculated according to AOCS Cd 1 c-85 based on total acids bound as acyl groups in glycerides in the fat composition being based on the total weight of C8 to C24 fatty acids. Iodine value can alternatively be measured by AOCS Method Cd 1-25.

The fat composition according to the invention preferably has a content of trans fatty acid residues of less than 2% by weight, more preferably less than 1.5% by weight and even more preferably less than 1.0% by weight; said percentage of acid being based on the total weight of C8 to C24 fatty acids.

The fat composition according to the invention preferably comprises at most 4.0% by weight of PPP triglycerides, more preferably from 0% to 3.5% by weight, even more preferably from 0.1% to 3.0% and most preferably from 0.2% to 2.5% by weight; based on the total glycerides present in the fat composition, wherein P is palmitic acid.

The fat composition according to the invention preferably comprises from 10% to 35% by weight of OPL triglycerides, more preferably from 12% to 32% by weight, even more preferably from 14% to 30% by weight and most preferably from 16% to 28% by weight; based on the total glycerides present in the fat composition, wherein P is palmitic acid, O is oleic acid and L is linoleic acid.

The fat composition according to the invention preferably comprises from 10% to 35% by weight of OPO triglycerides, more preferably from 12% to 32% by weight, even more preferably from 14% to 30% by weight and most preferably from 16% to 28% by weight; based on the total glycerides present in the fat composition, wherein P is palmitic acid and O is oleic acid.

The fat composition according to the invention preferably comprises from 3% to 20% by weight of LPL triglycerides, more preferably from 5% to 18% by weight, even more preferably from 7% to 17% by weight and most preferably from 8% to 16% by weight; based on the total glycerides present in the fat composition, wherein P is palmitic acid and L is linoleic acid.

The fat composition according to the invention preferably has a weight ratio of OPL triglycerides to OPO triglycerides of from 0.85 to 1.50, more preferably from 0.90 to 1.40, even more preferably from 0.95 to 1.30 and most preferably from 1.00 to 1.20; based on the total glycerides present in the fat composition. The preferred weight ratios of OPL triglycerides to OPO triglycerides are particularly desirable, as the balance between these two triglycerides are thought to be important nutritionally in the fat composition and infant formula product. This feature is also believed to be linked to an improvement of the oxidative stability in particular.

Accordingly, in a preferred embodiment, the fat composition according to the invention comprises at most 4.0% by weight of PPP triglycerides; from 10% to 35% by weight of OPL triglycerides; from 10% to 35% by weight of OPO triglycerides; and from 3% to 20% by weight of LPL triglycerides; and has a weight ratio of OPL triglycerides to OPO triglycerides from 0.85 to 1.50; based on the total glycerides present in the fat composition.

In a more preferred embodiment, the fat composition according to the invention comprises from 0% to 3.5% by weight of PPP triglycerides; from 12% to 32% by weight of OPL triglycerides; from 12% to 32% by weight of OPO triglycerides; and from 5% to 18% by weight of LPL triglycerides; and has a weight ratio of OPL triglycerides to OPO triglycerides from 0.90 to 1.40; based on the total glycerides present in the fat composition.

In an even more preferred embodiment, the fat composition according to the invention comprises from 0.1% to 3.0% by weight of PPP triglycerides; from 14% to 30% by weight of OPL triglycerides; from 14% to 30% by weight of OPO triglycerides; and from 7% to 17% by weight of LPL triglycerides; and has a weight ratio of OPL triglycerides to OPO triglycerides from 0.95 to 1.30; based on the total glycerides present in the fat composition.

In a most preferred embodiment, the fat composition according to the invention comprises from 0.2% to 2.5% by weight of PPP triglycerides; from 16% to 28% by weight of OPL triglycerides; from 16% to 28% by weight of OPO triglycerides; and from 8% to 16% by weight of LPL triglycerides; and has a weight ratio of OPL triglycerides to OPO triglycerides from 1.00 to 1.20; based on the total glycerides present in the fat composition.

The fat composition according to the invention preferably comprises from 2% to 25% by weight of PPL triglycerides, more preferably from 4% to 22% by weight, even more preferably from 6% to 20% by weight and most preferably from 8% to 18% by weight; based on the total glycerides present in the fat composition.

The fat composition according to the invention preferably comprises from 5% to 35% by weight of PPO triglycerides, more preferably from 7% to 30% by weight, even more preferably from 9% to 25% by weight and most preferably from 10% to 18% by weight; based on the total glycerides present in the fat composition.

The fat composition according to the invention preferably has a weight ratio of PPL triglycerides to PPO triglycerides of from 0.30 to 1.60, more preferably from 0.40 to 1.55, even more preferably from 0.50 to 1.50 and most preferably from 0.60 to 1.50; based on the total glycerides present in the fat composition. These preferred weight ratios of PPL triglycerides to PPO triglycerides are particularly desired, optionally together with the weight ratios of OPL triglycerides to OPO triglycerides, to obtain a favorable balance amongst the nutritionally important triglycerides and the fatty acid composition while maintaining the high level of palmitic acid on the SN-2 position in the fat composition according to the invention.

Accordingly, in a preferred embodiment, the fat composition according to the invention comprises from 2% to 25% by weight of PPL triglycerides; and from 5% to 35% by weight of PPO triglycerides; and has a weight ratio of PPL triglycerides to PPO triglycerides of from 0.30 to 1.60; based on the total glycerides present in the fat composition.

In a more preferred embodiment, the fat composition according to the invention comprises from 4% to 22% by weight of PPL triglycerides; and from 7% to 30% by weight of PPO triglycerides; and has a weight ratio of PPL triglycerides to PPO triglycerides of from 0.40 to 1.55; based on the total glycerides present in the fat composition.

In an even more preferred embodiment, the fat composition according to the invention comprises from 6% to 20% by weight of PPL triglycerides; and from 9% to 25% by weight of PPO triglycerides; and has a weight ratio of PPL triglycerides to PPO triglycerides of from 0.50 to 1.50; based on the total glycerides present in the fat composition.

In a most preferred embodiment, the fat composition according to the invention comprises from 8% to 18% by weight of PPL triglycerides; and from 10% to 18% by weight of PPO triglycerides; and has a weight ratio of PPL triglycerides to PPO triglycerides of from 0.60 to 1.50; based on the total glycerides present in the fat composition.

Accordingly, in a preferred embodiment, the fat composition according to the invention comprises at most 5% by weight of lauric acid (C12:0); from 23% to 48% by weight of palmitic acid (C16:0); from 22% to 45% by weight of oleic acid (C18:1); from 18% to 38% by weight of linoleic acid (C18:2); and at most 5% by weight of linolenic acid (C18:3); and has a weight ratio of oleic acid (C18:1) to linoleic acid (C18:2) of from 0.6 to 2.2; said percentages of acid being based on the total weight of C8 to C24 fatty acids; and a percentage of palmitic acid on the second position of triglyceride out of total palmitic acid (SN-2 of C16:0) at least 45%; and wherein the fat composition comprises at most 4.0% by weight of PPP triglycerides; from 10% to 35% by weight of OPL triglycerides; from 10% to 35% by weight of OPO triglycerides; from 3% to 20% by weight of LPL triglycerides; from 2% to 25% by weight of PPL triglycerides; and from 5% to 35% by weight of PPO triglycerides; and has a weight ratio of OPL triglycerides to OPO triglycerides of from 0.85 to 1.50 and a weight ratio of PPL triglycerides to PPO triglycerides of from 0.30 to 1.60; based on the total glycerides present in the fat composition.

In a more preferred embodiment, the fat composition according to the invention comprises from 0% to 4% by weight of lauric acid (C12:0); from 25% to 45% by weight of palmitic acid (C16:0); from 25% to 43% by weight of oleic acid (C18:1); from 19% to 35% by weight of linoleic acid (C18:2); and from 0% to 4% by weight of linolenic acid (C18:3); and has a weight ratio of oleic acid (C18:1) to linoleic acid (C18:2) of from 0.8 to 2.0; said percentages of acid being based on the total weight of C8 to C24 fatty acids; and a percentage of palmitic acid on the second position of triglyceride out of total palmitic acid (SN-2 of C16:0) from 50% to 80%; and wherein the fat composition comprises from 0% to 3.5% by weight of PPP triglycerides; from 12% to 32% by weight of OPL triglycerides; from 12% to 32% by weight of OPO triglycerides; from 5% to 18% by weight of LPL triglycerides; from 4% to 22% by weight of PPL triglycerides; and from 7% to 30% by weight of PPO triglycerides; and has a weight ratio of OPL triglycerides to OPO triglycerides of from 0.90 to 1.40 and a weight ratio of PPL triglycerides to PPO triglycerides of from 0.40 to 1.55; based on the total glycerides present in the fat composition.

In an even more preferred embodiment, the fat composition according to the invention comprises from 0% to 3% by weight of lauric acid (C12:0); from 28% to 43% by weight of palmitic acid (C16:0); from 27% to 41% by weight of oleic acid (C18:1); from 20% to 32% by weight of linoleic acid (C18:2); and from 0% to 3.5% by weight of linolenic acid (C18:3); and has a weight ratio of oleic acid (C18:1) to linoleic acid (C18:2) of from 0.9 to 1.8; said percentages of acid being based on the total weight of C8 to C24 fatty acids; and a percentage of palmitic acid on the second position of triglyceride out of total palmitic acid (SN-2 of C16:0) from 55% to 75%; and wherein the fat composition comprises from 0.1% to 3.0% by weight of PPP triglycerides; from 14% to 30% by weight of OPL triglycerides; from 14% to 30% by weight of OPO triglycerides; from 7% to 17% by weight of LPL triglycerides; from 6% to 20% by weight of PPL triglycerides; and from 9% to 25% by weight of PPO triglycerides; and has a weight ratio of OPL triglycerides to OPO triglycerides of from 0.95 to 1.30 and a weight ratio of PPL triglycerides to PPO triglycerides of from 0.50 to 1.50; based on the total glycerides present in the fat composition.

In a most preferred embodiment, the fat composition according to the invention comprises from 0% to 2% by weight of lauric acid (C12:0); from 30% to 40% by weight of palmitic acid (C16:0); from 28% to 41% by weight of oleic acid (C18:1); from 20% to 30% by weight of linoleic acid (C18:2); and from 0% to 3% by weight of linolenic acid (C18:3); and has a weight ratio of oleic acid (C18:1) to linoleic acid (C18:2) of from 1.0 to 1.7; said percentages of acid being based on the total weight of C8 to C24 fatty acids; and a percentage of palmitic acid on the second position of triglyceride out of total palmitic acid (SN-2 of C16:0) from 60% to 70%; and wherein the fat composition comprises from 0.2% to 2.5% by weight of PPP triglycerides; from 16% to 28% by weight of OPL triglycerides; from 16% to 28% by weight of OPO triglycerides; from 8% to 16% by weight of LPL triglycerides; from 8% to 18% by weight of PPL triglycerides; and from 10% to 18% by weight of PPO triglycerides; and has a weight ratio of OPL triglycerides to OPO triglycerides of from 1.00 to 1.20 and a weight ratio of PPL triglycerides to PPO triglycerides of from 0.60 to 1.50; based on the total glycerides present in the fat composition.

The invention also relates to a substitute human milk fat blend comprising at least 15% by weight of the fat composition according to the invention, preferably at least 20% by weight, more preferably at least 25% by weight and even more preferably from 25% to 80% by weight. The substitute human milk fat blend according to the invention is particularly suitable for use in an infant formula, such as replacing at least a part of the fat in infant formula. The substitute human milk fat blend preferably further comprises one or more vegetable oils selected from the group consisting of soybean oil, palm oil, rapeseed oil, canola oil, coconut oil, palm kernel oil, sunflower oil, corn oil, linseed oil, flaxseed oil, safflower oil, high oleic sunflower oil, high oleic safflower oil and fractions thereof. The substitute human milk fat blend may preferably further comprise milk fat, such as milk fat derived from cow's milk. The substitute human milk fat blend may also preferably further comprises synthetic oils such as MCT oil (medium-chain triglyceride oil) or MLCT oil (medium-long-chain triglyceride oil).

The invention also relates to an infant formula comprising the substitute human milk fat blend of the invention. The infant formula preferably comprises one or more further ingredients selected from protein, vitamins, minerals, nucleotides, amino acids and carbohydrates. The infant formula may be in liquid form or in the form of a dry formulation, such as a powder or granules.

The invention also relates to the use of the fat composition according to the invention to prepare a substitute human milk fat blend for infant formula.

The invention also relates to the use of the substitute human milk fat blend according to the invention to prepare an infant formula.

The invention also relates to a process of preparing the fat composition according to the invention comprising the step of a) preparing a first fat composition comprising at least 15% by weight of OPO triglycerides, preferably at least 25% by weight; based on the total glycerides present in the fat, wherein P is palmitic acid and O is oleic acid; and having a percentage of palmitic acid on the second position of triglyceride out of total palmitic acid (SN-2 of C16:0) at least 40%, preferably from 45% to 80%; b) preparing a second fat composition comprising at least 8% by weight of OPL triglyceride, preferably from 10% to 35% by weight; based on the total glycerides present in the fat, wherein P is palmitic acid, O is oleic acid and L is linoleic acid; and having a percentage of palmitic acid on the second position of triglyceride out of total palmitic acid (SN-2 of C16:0) at least 50%, preferably from 52% to 80%; and c) blending the first fat composition prepared in step a) and the second fat composition prepared in step b) in a weight ratio of from 90:10 to 10:90, preferably from 80:20 to 20:80 to form the fat composition of the invention.

The process to produce the first fat composition comprising OPO triglycerides in the step a) of the invention may be carried out as described in, for example, WO 2007/029018. The processing steps as described in WO 2007/029018 comprise (i) providing a palm oil stearin comprising tripalmitoyl glyceride; (ii) optionally bleaching and deodorizing the palm oil stearin; (iii) subjecting the palm oil stearin to enzymic transesterification with oleic acid or a non-glyceride ester thereof; (iv) separating palmitic acid or palmitic non-glyceride esters from the product obtained in (iii) to form a composition comprising OPO glyceride; and (v) optionally dry fractionating the product obtained in (iv) to form a fraction comprising an increased amount of OPO.

The process to produce the first fat composition comprising OPO triglycerides in the step a) of the invention may also be carried out as described in U.S. Pat. No. 5,658,768. The processing steps as described in U.S. Pat. No. 5,658,768 comprise 1) converting triglyceride A high in trisaturates enzymatically with a 1,3-specific enzyme and the unsaturated acid source B in a first enzymic conversion zone; 2) removing spent unsaturated acid source B from crude product obtained in step 1); 3) optionally subjecting any remaining part of the crude product in step 2) to an enzymic removal of diglyceride; 4) converting the remaining part of the crude product of step 2) or product of step 3) in a second enzymic conversion zone with a fresh source of unsaturated acid source B in the presence of a 1,3-specific enzyme; 5) removing spent unsaturated acid source B from crude product of step 4); 6) optionally recirculating the spent unsaturated acid source B from step 5) to step 1); 7) decreasing the level of trisaturates in any remaining product of step 5) by further enzymic treatment, using a 1,3-specific enzyme by contacting the product of step 5) with an oil blend consisting essentially of triglycerides with saturated acid in the 1,3-positions, less than 40 wt. % of the fatty acids in the 2-position of said oil blend triglycerides being saturated fatty acids with 16 to 22 C-atoms.

The unsaturated free fatty acids source used in step a) of the process according to the invention may be an oleic acids source which preferably comprises at least 60% oleic acid (C18:1) by weight, more preferably at least 65% by weight, even more preferably at least 70% by weight and most preferably at least 75% by weight.

The process to produce the second fat composition comprising OPL triglycerides in the step b) of the invention may be performed in the same way as in the step a) and increasing the level of linoleic acid (C18:2) in the unsaturated free fatty acids to react with palm stearin or a source high in tripalmitin.

The suitable unsaturated free fatty acids source may be derived from sunflower oil, soybean oil, rapeseed oil, olive oil, salicornia oil, safflower oil, evening primrose oil, melon seed oil, poppyseed oil, grape seed oil, prickly pear seed oil, barbary fig seed oil, hemp oil, corn oil, wheat germ oil, cottonseed oil, walnut oil, sesame oil, rice bran oil, argan oil, pistachio oil, peanut oil, peach oil, almonds oil, canola oil, linseed oil, olive oil, palm oil and mixtures thereof. The unsaturated free fatty acids source used in step b) of the process according to the invention may be from one single source as mentioned above, such as unsaturated free fatty acids from sunflower oil. The unsaturated free fatty acids source used in step b) of the process according to the invention may also be a blend of the oleic acids sources as mentioned in step a) with the unsaturated free fatty acids source mentioned above, such as a blend of commercial oleic acid with unsaturated free fatty acids from soybean oil or a blend of commercial oleic acid with unsaturated free fatty acids from sunflower oil. The unsaturated free fatty acids source used in step b) of the process according to the invention preferably has a weight ratio of oleic acid (C18:1) to linoleic acid (C18:2) of from 0.40 to 1.50, more preferably from 0.50 to 1.25 and even more preferably from 0.50 to 1.00.

In step a) of the process according to the invention, the first fat composition comprises at least 15% by weight of OPO triglycerides, preferably at least 25% by weight and more preferably from 25% to 45% by weight; based on the total glycerides present in the fat.

In step a) of the process according to the invention, the first fat composition has a percentage of palmitic acid on the second position of triglyceride out of total palmitic acid (SN-2 of C16:0) at least 40%, preferably from 45% to 80%, more preferably from 50% to 75% and most preferably from 52% to 72%.

In step b) of the process according to the invention, the second fat composition comprises at least 8% by weight of OPL triglyceride, preferably from 10% to 35% by weight and more preferably from 11% to 30% by weight; based on the total glycerides present in the fat.

In step b) of the process according to the invention, the second fat composition has a percentage of palmitic acid on the second position of triglyceride out of total palmitic acid (SN-2 of C16:0) at least 50%, preferably from 52% to 80%, more preferably from 55% to 75% and more preferably from 60% to 73%.

In step c) of the process according to the invention, the first fat composition prepared in step a) is blended with the second fat composition prepared in step b) in a weight ratio of from 90:10 to 10:90, preferably from 80:20 to 20:80 and more preferably from 50:50 to 20:80 to form the fat composition of the invention.

Accordingly, in a more preferred embodiment, the process of preparing the fat composition according to the invention comprising the step of a) preparing a first fat composition comprising from 25% to 45% by weight of OPO triglycerides; based on the total glycerides present in the fat; and having a percentage of palmitic acid on the second position of triglyceride out of total palmitic acid (SN-2 of C16:0) from 53% to 72%; b) preparing a second fat composition comprising from 11% to 30% by weight of OPL triglyceride; based on the total glycerides present in the fat; and having a percentage of palmitic acid on the second position of triglyceride out of total palmitic acid (SN-2 of C16:0) from 60% to 73%; and c) blending the first fat composition prepared in step a) and the second fat composition prepared in step b) in a weight ratio of from 50:50 to 20:80 to form the fat composition of the invention.

The fat composition obtained in step c) according to the invention is preferably further refined. The term “refined”, as used herein, refers to processes in which the purity of an oil or fat is increased by a process which comprises processing steps such as neutralization, distillation, absorption, bleaching, filtration and deodorization (such as by steam refining), etc. More preferably, the fat composition is neutralized, bleached and deodorized. Alternatively, the first fat composition obtained in step a) and the second fat composition obtained in step b) may preferably be separately refined before step c), more preferably neutralized, bleached and deodorized. The deodorization conditions are preferably performed at a temperature lower than 240° C., more preferably lower than 220° C. and even more preferably from 180° C. to 210° C.

The invention also relates to a process of preparing a substitute human milk fat blend of the invention, comprising blending the fat composition according to the invention with one or more vegetable oils selected from the group consisting of soybean oil, palm oil, rapeseed oil, canola oil, coconut oil, palm kernel oil, sunflower oil, corn oil, linseed oil, flaxseed oil, safflower oil, high oleic sunflower oil, high oleic safflower oil and fractions thereof.

The invention also relates to a process of preparing an infant formula of the invention, comprising combining a substitute human milk fat blend according to the invention with one or more further ingredients selected from protein, vitamins, minerals, nucleotides, amino acids and carbohydrates.

The infant formula is typically prepared in the form of a ready-to-feed liquid, a liquid concentrate for dilution prior to consumption, or a powder that is reconstituted prior to consumption. For example, the process may involve the initial formation of an aqueous slurry comprising the fat blend and cow's milk, optionally with further carbohydrates, proteins, lipids, stabilizers or other formulation aids, vitamins, minerals, or combinations thereof. The slurry may be emulsified and/or pasteurized and/or homogenized. Various other solutions, mixtures, or other materials may be added to the resulting emulsion before, during, or after further processing. This emulsion can then be further diluted, heat-treated, and packaged to form a ready-to-feed or concentrated liquid, or it can be heat-treated and subsequently processed and packaged as a reconstitutable powder, e.g., spray dried, dry mixed or agglomerated.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

The following non-limiting examples illustrate the invention and do not limit its scope in any way. In the examples and throughout this specification, all percentages, parts and ratios are by weight unless indicated otherwise.

### EXAMPLES

Throughout these examples:
Cx:y refers to a fatty acid having x carbon atoms and y double bonds; levels determined by GC-FAME (ISO 12966-2 and ISO 12966-4);
TRANS refers to trans fatty acids;
M, O, P, St, L and A refer to myristic, oleic, palmitic, stearic, linoleic and arachidic acids, respectively;
Triglyceride compositions: POSt, and other triglycerides were determined by GC (ISO 23275), wherein each GC peak includes triglycerides having the same fatty acids in different positions e.g., POSt is in the same signal peak as PStO and StOP;
SN-2 of C16:0 refers to the percentage C16:0 present in the 2-monoglyceride in comparison of the percentage C16:0 in the test sample. The distribution of fatty acids in triglyceride was determined after chemical degradation with a Grignard reagent according to Becker, C. C. et al. (1993) Lipids, 28, 147-149. The percentage of C16:0 residues in the 2-position was determined by finding: (a) the total C16:0 content of the fat by GC-FAME (ISO 12966-2 and ISO 12966-4); and (b) the C16:0 content of the 2-position by GC-FAME (ISO 12966-2 and ISO 12966-4) in 2-monoglyceride after chemical degradation with a Grignard reagent. The Sn-2 of C16:0 was thus ((b)×100)/((a)×3);
Iodine value was calculated according to AOCS Cd 1c-85;
Peroxide value was determined according to AOCS Cd 8b-90 and expressed in unit meqO₂/kg;
p-Anisidine value was determined according to AOCS Cd 18-90 and expressed in unit value; and
Rancimat Induction Period at 120° C. is determined according to AOCS Cd 12b-92 and expressed in unit hours.

### Example 1—Preparation of Two OPO Compositions

OPO composition 1 was prepared according to WO 2007/029018 from a palm stearin with an iodine value (IV) between 2 and 12 and oleic acid via 1,3-specific enzymatic reaction by using 1,3-specific enzyme such as immobilized Lipase D (Rhizopus oryzae, previously classified as Rhizopus delemar, from Amano Enzyme Inc., Japan). The free fatty acids were removed by distillation after each stage of reaction.

OPO composition 2 was prepared according to U.S. Pat. No. 5,658,768 from a palm stearin of more than 60% by weight of tripalmitin and oleic acid via two-stage 1,3-specific acidolysis reaction by using 1,3-specific enzyme such as immobilized Lipase D (Rhizopus oryzae, previously classified as Rhizopus delemar, from Amano Enzyme Inc., Japan). The free fatty acids were removed by distillation after each stage of reaction.

The analytical results of the obtained OPO composition 1 and OPO composition 2 are shown in Table 1.

TABLE 1
Analytical results of the OPO composition 1 and OPO composition 2.

| | OPO composition 1 | OPO composition 2 |
|---|---|---|
| C8:0 | 0.0 | 0.0 |
| C10:0 | 0.0 | 0.0 |
| C12:0 | 0.6 | 0.1 |
| C14:0 | 0.7 | 0.4 |
| C15:0 | 0.0 | 0.0 |
| C16:0 | 40.8 | 31.3 |
| C16:1 | 0.0 | 0.0 |
| C17:0 | 0.1 | 0.1 |
| C18:0 | 3.8 | 2.8 |
| C18:1 | 45.9 | 55.7 |
| C18:2 | 7.6 | 9.0 |
| C18:3 | 0.3 | 0.3 |
| C20:0 | 0.2 | 0.2 |
| C20:1 | 0.0 | 0.0 |
| C22:0 | 0.0 | 0.0 |
| C22:1 | 0.0 | 0.0 |
| C24:0 | 0.0 | 0.0 |
| TRANS | 0.7 | 0.7 |
| MPP | 0.3 | 0.1 |
| MOM | 0.1 | 0.1 |
| PPP | 7.2 | 2.1 |
| MOP | 1.0 | 0.5 |
| MLP | 0.2 | 0.1 |
| PPSt | 1.8 | 0.7 |
| PPO | 26.3 | 17.0 |
| MOO | 0.3 | 0.2 |
| PPL | 4.3 | 3.0 |
| MLO | 0.1 | 0.1 |
| PStSt | 0.3 | 0.1 |
| POSt | 4.6 | 3.1 |
| OPO | 30.2 | 39.7 |
| PLSt | 1.2 | 0.6 |
| OPL | 9.3 | 11.5 |
| LPL | 0.7 | 0.8 |
| StStSt | 0.0 | 0.0 |
| StOSt | 0.7 | 0.6 |
| StOO | 2.1 | 2.6 |
| StLSt | 0.0 | 0.0 |
| OOO | 5.6 | 10.6 |
| StLO | 0.6 | 0.5 |
| OLO | 2.4 | 4.6 |
| StLL | 0.2 | 0.3 |
| OLL | 0.4 | 0.8 |
| AStSt | 0.0 | 0.0 |
| AOSt | 0.1 | 0.1 |
| AOO | 0.1 | 0.1 |
| ALSt | 0.0 | 0.1 |
| SN-2 of C16:0 | 55.9 | 70.1 |
| OPL/OPO | 0.31 | 0.29 |

### Example 2—Preparation of Three Free Fatty Acid (FFA) Compositions

Three free fatty acid (FFA) compositions were prepared by blending different sources of free fatty acids—commercial oleic acid, FFA derived from sunflower oil and FFA derived from soybean oil. FFA composition A is 100% by weight of free fatty acids derived from sunflower oil. FFA composition B was prepared by blending 21% by weight of commercial oleic acid with 79% by weight of free fatty acids derived from soybean oil. FFA composition C was prepared by blending 30% by weight of commercial oleic acid with 70% by weight of free fatty acids derived from sunflower oil.

The analytical results of commercial oleic acid, FFA derived from sunflower oil, FFA derived from soybean oil, FFA compositions A, B and C are shown in Table 2.

TABLE 2
Analytical results of commercial oleic acid, FFA derived from sunflower
oil, FFA derived from soybean oil, FFA compositions A, B and C.

| | | FFA | FFA | | | |
|---|---|---|---|---|---|---|
| | | derived | derived | | | |
| | | from | from | FFA | FFA | FFA |
| | Commercial | sunflower | soybean | composition | composition | composition |
| | oleic acid | oil | oil | A | B | C |
| C8:0 | 0.0 | 0.0 | 0.0 | 0.0 | 0.0 | 0.0 |
| C10:0 | 0.0 | 0.0 | 0.0 | 0.0 | 0.0 | 0.0 |
| C12:0 | 0.0 | 0.1 | 0.0 | 0.1 | 0.1 | 0.0 |
| C14:0 | 0.0 | 0.1 | 0.1 | 0.1 | 0.1 | 0.1 |
| C15:0 | 0.0 | 0.0 | 0.0 | 0.0 | 0.0 | 0.0 |
| C16:0 | 1.7 | 6.2 | 11.0 | 6.2 | 9.1 | 5.0 |
| C16:1 | 0.0 | 0.1 | 0.1 | 0.1 | 0.0 | 0.1 |
| C17:0 | 0.1 | 0.0 | 0.1 | 0.0 | 0.1 | 0.1 |
| C18:0 | 2.5 | 3.4 | 3.8 | 3.4 | 3.7 | 3.4 |
| C18:1 | 81.0 | 31.8 | 24.4 | 31.8 | 36.2 | 44.0 |
| C18:2 | 13.0 | 57.3 | 52.9 | 57.3 | 44.0 | 45.9 |
| C18:3 | 0.5 | 0.2 | 7.1 | 0.2 | 5.4 | 0.3 |
| C20:0 | 0.2 | 0.2 | 0.1 | 0.2 | 0.2 | 0.2 |
| C20:1 | 0.0 | 0.0 | 0.4 | 0.0 | 0.0 | 0.0 |
| C22:0 | 0.0 | 0.0 | 0.1 | 0.0 | 0.1 | 0.4 |
| C22:1 | 0.0 | 0.0 | 0.0 | 0.0 | 0.0 | 0.1 |
| C24:0 | 0.0 | 0.2 | 0.0 | 0.2 | 0.0 | 0.0 |
| TRANS | 1.0 | 0.2 | 0.7 | 0.2 | 0.9 | 0.6 |

### Example 3—Preparation of OPL Composition A

A fatty mixture of 30% by weight of palm oil stearin having iodine value (IV) of about 12 and 70% by weight of FFA composition A obtained in Example 2 was prepared. The acidolysis reaction of this fatty mixture was performed over immobilized Lipase D as catalyst at 60° C. in a packed bed reactor with a flow of approximatively 6.7 g fatty mixture/g immobilized enzyme/hour. After the reaction, the free fatty acid residues were removed via short-path distillation at 210° C. under vacuum of 0.003 mbar. The fat product after distillation was further dry fractionated in order to remove the hard fat fraction. The dry fractionation was performed at 20° C. About 89% olein fraction after dry fractionation was obtained as OPL composition A.

The analytical results of OPL composition A are shown in Table 3.

TABLE 3
Analytical results of OPL composition A.

| | OPL composition A |
|---|---|
| C16:0 | 36.6 |
| C18:0 | 3.3 |
| C18:1 | 21.7 |
| C18:2 | 37.1 |
| C18:3 | 0.1 |
| C22:1 | 0.0 |
| TRANS | 0.2 |
| PPP | 0.2 |
| PPO | 9.9 |
| PPL | 24.8 |
| OPO | 5.1 |
| OPL | 21.3 |
| SN-2 of C16:0 | 66.1 |
| OPL/OPO | 4.21 |

### Example 4—Preparation of OPL Composition B

A fatty mixture of 40% by weight of palm oil stearin having iodine value (IV) of about 12 and 60% by weight of FFA composition B obtained in Example 2 was prepared. The acidolysis reaction of this fatty mixture was performed over immobilized Lipase D as catalyst at 60° C. in a packed bed reactor with a flow of approximatively 5 g fatty mixture/g immobilized enzyme/hour. After the reaction, the free fatty acid residues were removed via short-path distillation at 210° C. under vacuum of 0.001 mbar. The fat product after was is further fractionated in acetone as solvent in order to remove the hard fat fraction. The solvent fractionation was performed at about 4° C. where the ratio of fat to acetone was approximative 1:4 (w/v). About 65% olein fraction after solvent fractionation was obtained as OPL composition B.

The analytical results of OPL composition B are shown in Table 4.

TABLE 4
Analytical results of OPL composition B.

| | OPL composition B |
|---|---|
| C16:0 | 32.1 |
| C18:0 | 2.5 |
| C18:1 | 34.8 |
| C18:2 | 26.0 |
| C18:3 | 2.8 |
| C22:1 | 0.0 |
| TRANS | 0.1 |
| PPP | 0.7 |
| PPO | 0.2 |
| PPL | 0.6 |
| OPO | 1.9 |
| OPL | 12.9 |
| SN-2 of C16:0 | 65.1 |
| OPL/OPO | 1.59 |

### Example 5—Preparation of OPL Composition C

A fatty mixture of 30% by weight of palm oil stearin having iodine value (IV) of about 12 and 70% by weight of FFA composition C obtained in Example 2 was prepared. The acidolysis reaction of this fatty mixture was performed over immobilized Lipase D as catalyst at 60° C. in a packed bed reactor with a flow of approximatively 6.7 g fatty mixture/g immobilized enzyme/hour. After the reaction, the free fatty acid residues were removed via short-path distillation at 210° C. under vacuum of 0.003 mbar. The fat product after distillation was further dry fractionated in order to remove the hard fat fraction. The dry fractionation was performed at 24° C. About 90% olein fraction after solvent fractionation was obtained as OPL composition C.

The analytical results of OPL composition C are shown in Table 5.

TABLE 5
Analytical results of OPL composition C.

| | OPL composition C |
|---|---|
| C16:0 | 35.4 |
| C18:0 | 3.0 |
| C18:1 | 31.8 |
| C18:2 | 28.5 |
| C18:3 | 0.2 |
| C22:1 | 0.0 |
| TRANS | 0.4 |
| PPP | 0.5 |
| PPO | 15.2 |
| PPL | 16.8 |
| OPO | 13.8 |
| OPL | 24.3 |
| SN-2 of C16:0 | 65.5 |
| OPL/OPO | 1.75 |

### Example 6—Preparation of OPO/OPL Fat Compositions

Three OPO/OPL fat compositions were prepared by blending OPO compositions 1 and 2 obtained in Example 1 and OPL compositions A, B and C obtained in Examples 3-5 respectively. OPO/OPL fat composition A is composed by 30% by weight of OPO composition 2 and 70% by weight of OPL composition A. OPO/OPL fat composition B is composed by 20% by weight of OPO composition 1 and 80% by weight of OPL composition B. OPO/OPL fat composition C is composed by 24% by weight of OPO composition 2 and 76% by weight of OPL composition C.

The analytical results of OPO/OPL fat compositions A, B and C are shown in Table 6.

TABLE 6
Analytical results of OPO/OPL fat compositions A, B and C.

| | OPO/OPL fat | OPO/OPL fat | OPO/OPL fat |
|---|---|---|---|
| | composition A | composition B | composition C |
| C8:0 | 0.0 | 0.0 | 0.0 |
| C10:0 | 0.0 | 0.0 | 0.0 |
| C12:0 | 0.0 | 0.2 | 0.0 |
| C14:0 | 0.4 | 0.7 | 0.5 |
| C15:0 | 0.0 | 0.0 | 0.0 |
| C16:0 | 34.2 | 33.5 | 31.5 |
| C16:1 | 0.1 | 0.1 | 0.1 |
| C17:0 | 0.1 | 0.1 | 0.1 |
| C18:0 | 3.0 | 2.8 | 2.9 |
| C18:1 | 31.8 | 37.3 | 31.8 |
| C18:2 | 29.9 | 22.6 | 24.0 |
| C18:3 | 0.2 | 2.5 | 0.2 |
| C20:0 | 0.2 | 0.2 | 0.2 |
| C20:1 | 0.0 | 0.1 | 0.0 |
| C22:0 | 0.1 | 0.1 | 0.1 |
| C22:1 | 0.0 | 0.0 | 0.0 |
| C24:0 | 0.1 | 0.0 | 0.1 |
| TRANS | 0.4 | 0.7 | 0.5 |
| Iodine value | 80 | 78 | 70 |
| C18:1/C18:2 | 1.06 | 1.65 | 1.33 |
| MPP | 0.1 | 0.1 | 0.1 |
| MOM | 0.1 | 0.1 | 0.0 |
| PPP | 0.8 | 1.7 | 0.9 |
| MOP | 0.6 | 0.8 | 0.7 |
| MLP | 0.4 | 0.4 | 0.4 |
| PPSt | 0.2 | 0.3 | 0.1 |
| PPO | 11 .1 | 14.0 | 15.2 |
| MOO | 0.4 | 0.1 | 0.1 |
| PPL | 16.5 | 8.9 | 12.2 |
| MLO | 0.1 | 0.4 | 0.1 |
| PStSt | 0.1 | 0.1 | 0.2 |
| POSt | 2.1 | 2.2 | 3.1 |
| OPO | 17.8 | 20.7 | 19.9 |
| PLSt | 1.0 | 1.9 | 2.1 |
| OPL | 19.2 | 24.2 | 21.9 |
| LPL | 15.1 | 10.0 | 8.8 |
| StStSt | 0.0 | 0.0 | 0.0 |
| StOSt | 0.2 | 0.2 | 0.3 |
| StOO | 0.9 | 1.4 | 1.3 |
| StLSt | 0.0 | 0.0 | 0.0 |
| OOO | 3.4 | 3.3 | 3.9 |
| StLO | 1.2 | 1.3 | 1.3 |
| OLO | 3.9 | 4.7 | 4.2 |
| StLL | 0.4 | 0.4 | 0.5 |
| OLL | 3.6 | 2.8 | 2.3 |
| AStSt | 0.0 | 0.0 | 0.0 |
| AOSt | 0.8 | 0.0 | 0.3 |
| AOO | 0.1 | 0.1 | 0.0 |
| ALSt | 0.1 | 0.0 | 0.0 |
| SN-2 of | 67.3 | 61.6 | 64.0 |
| C16:0 | | | |
| OPL/OPO | 1.08 | 1.17 | 1.10 |
| PPL/PPO | 1.49 | 0.64 | 0.80 |

### Example 7—Preparation of Comparative Fat Composition D and Comparison Between OPO/OPL Fat Composition C and Comparative Fat Composition D

Comparative fat composition D was prepared according to the same process to produce “Fat base 3” described in EP-A-3583857 via 1,3-specific enzymatic reaction. The free fatty acids were removed by distillation.

Both OPO/OPL fat composition C according to the invention and Comparative fat composition D were chemically refined under the exact same conditions in order to have a fair and meaningful comparison. The chemical refining included the steps (in order) of neutralization at 90° C., degumming with 0.02% of 50% w/w citric acid, bleaching with 1.5% bleaching earth and 0.3% activated carbon and deodorization at 200° C. to reach a final % FFA (as oleic) of <1.5%. Both refined OPO/OPL fat composition C and refined Comparative fat composition D were measured. The comparison analytical results of refined OPO/OPL fat composition C and refined Comparative fat composition D are shown in Table 7.

TABLE 7
Analytical results of refined OPO/OPL fat composition C
and refined Comparative fat composition D

| | refined Comparative | refined OPO/OPL |
|---|---|---|
| | fat | fat |
| | composition D | composition C |
| lodine value | 73 | 70 |
| C16:0 | 38.6 | 31.5 |
| C18:1 | 29.3 | 31.8 |
| C18:2 | 27.5 | 24.0 |
| C18:1/C18:2 | 1.07 | 1.33 |
| PPP | 5.7 | 0.9 |
| OPO | 11.9 | 19.9 |
| OPL | 21.4 | 21.9 |
| PPO | 15.5 | 15.2 |
| PPL | 15.1 | 12.2 |
| OPL/OPO | 1.80 | 1.10 |
| PPO/PPL | 0.97 | 0.80 |
| Peroxide value (O₂ meq/kg) | 0.1 | 0.1 |
| p-Anisidine value | 13.0 | 5.9 |
| Rancimat Induction Period | 0.8 | 1.5 |
| at 120° C. (h) | | |

It can be observed that the content of PPP triglycerides in OPO/OPL fat composition C is significantly lower than that in Comparative fat composition D as shown in Table 7. The low content of PPP triglycerides is particularly desired in a fat composition to be used in infant formula. It is believed to be beneficial for relieving constipation by reducing the calcium soap in stools while serving the fat blend as a functional ingredient in an infant formula application.

Meanwhile, OPO/OPL fat composition C has a weight ratio of OPL/OPO which is not only desired for a superior and balanced nutrition properties but also surprisingly shows a reduced aldehyde level measured as p-Anisidine value after refining, and more than 50% reduction and the double increase of Rancimat induction time which indicates a significant improvement of the stability of the oils (nevertheless while the unsaturation expressed as iodine values in both fat compositions is comparable). Due at least in part to the improved stability, the fat compositions according to the invention are particularly suitable for an infant formula product.

1. A fat composition, comprising:
from 20% to 50% by weight of palmitic acid (C16:0),
from 20% to 45% by weight of oleic acid (C18:1), and
from 17% to 40% by weight of linoleic acid (C18:2),
and having a weight ratio of oleic acid (C18:1) to linoleic acid (C18:2) of from 0.4 to 2.4, said percentages of acid being based on the total weight of C8 to C24 fatty acids;
wherein the percentage of palmitic acid on the second position of triglyceride (SN-2 of C16:0) is at least 40% based on the total palmitic acid; and
wherein the fat composition comprises at most 5.0% by weight of PPP triglycerides and has a weight ratio of OPL triglycerides to OPO triglycerides of from 0.80 to 1.60 based on the total glycerides present in the fat composition, wherein O is oleic acid, P is palmitic acid and L is linoleic acid.

2. The fat composition according to claim 1, wherein the fat composition has a weight ratio of oleic acid (C18:1) to linoleic acid (C18:2) of from 0.6 to 2.2.

3. The fat composition according to claim 1, wherein the fat composition comprises:
at most 5% by weight of lauric acid (C12:0); and/or
from 23% to 48% by weight of palmitic acid (C16:0); and/or
from 22% to 45% by weight of oleic acid (C18:1); and/or
from 18% to 38% by weight of linoleic acid (C18:2); and/or
at most 5% by weight of linolenic acid (C18:3);
said percentage of acid being based on the total weight of C8 to C24 fatty acids.

4. The fat composition according to claim 1, wherein the fat composition has a percentage of palmitic acid on the second position of triglyceride (SN-2 of C16:0) of at least 45% based on the total palmitic acid.

5. The fat composition according to claim 1, wherein the fat composition comprises:
at most 4.0% by weight of PPP triglycerides; and/or
from 10% to 35% by weight of OPL triglycerides; and/or
from 10% to 35% by weight of OPO triglycerides; and/or
from 3% to 20% by weight of LPL triglycerides;
based on the total glycerides present in the fat composition, wherein P is palmitic acid, O is oleic acid and L is linoleic acid.

6. The fat composition according to claim 1, wherein the fat composition has a weight ratio of OPL triglycerides to OPO triglycerides of from 0.85 to 1.50, based on the total glycerides present in the fat composition.

7. The fat composition according to claim 1, wherein the fat composition has a weight ratio of PPL triglycerides to PPO triglycerides of from 0.30 to 1.60, based on the total glycerides present in the fat composition, wherein O is oleic acid, P is palmitic acid and L is linoleic acid.

8. A substitute human milk fat blend comprising at least 15% by weight of the fat composition of claim 1.

9. The substitute human milk fat blend according to claim 8, further comprising one or more vegetable oils selected from the group consisting of soybean oil, palm oil, rapeseed oil, canola oil, coconut oil, palm kernel oil, sunflower oil, corn oil, linseed oil, flaxseed oil, safflower oil, high oleic sunflower oil, high oleic safflower oil, and fractions of thereof.

10. An infant formula comprising the substitute human milk fat blend of claim 8.

11. The infant formula according to claim 10, comprising one or more further ingredients selected from the group consisting of protein, vitamins, minerals, nucleotides, amino acids, and carbohydrates.

12. A method of using the fat composition of claim 1, the method comprising using the fat composition for preparing a substitute human milk fat blend for infant formula.

13. A method of using the substitute human milk fat blend of claim 8, the method comprising using the substitute human milk fat blend for preparing an infant formula.

14. A process of preparing the fat composition of claim 1 comprising the steps of
a) preparing a first fat composition comprising at least 15% by weight of OPO triglycerides, based on the total glycerides present in the fat composition, wherein P is palmitic acid and O is oleic acid, and having a percentage of palmitic acid on the second position of triglyceride (SN-2 of C16:0) of at least 40% based on the total palmitic acid;
b) preparing a second fat composition comprising at least 8% by weight of OPL triglyceride, based on the total glycerides present in the fat composition, wherein P is palmitic acid, O is oleic acid and L is linoleic acid; and having a percentage of palmitic acid on the second position of triglyceride (SN-2 of C16:0) of at least 50% based on the total palmitic acid; and
c) blending the first fat composition prepared in step a) and the second fat composition prepared in step b) in a weight ratio of from 90:10 to 10:90 to form the fat composition.

15. A process of preparing a substitute human milk fat blend comprising at least 15% by weight of the fat composition of claim 1, comprising blending the fat composition with one or more vegetable oils selected from the group consisting of soybean oil, palm oil, rapeseed oil, canola oil, coconut oil, palm kernel oil, sunflower oil, corn oil, linseed oil, flaxseed oil, safflower oil, high oleic sunflower oil, high oleic safflower oil, and fractions thereof.

16. A process of preparing an infant formula comprising a substitute human milk fat blend comprising at least 15% by weight of the fat composition of claim 1, comprising combining the substitute human milk fat blend with one or more further ingredients selected from the group consisting of protein, vitamins, minerals, nucleotides, amino acids, and carbohydrates.

17. The fat composition according to claim 1, wherein the fat composition has a weight ratio of oleic acid (C18:1) to linoleic acid (C18:2) of from 0.8 to 2.0.

18. The fat composition according to claim 1, wherein the fat composition comprises:
from 0% to 4% by weight of lauric acid (C12:0); and/or
from 25% to 45% by weight of palmitic acid (C16:0); and/or
from 25% to 43% by weight of oleic acid (C18:1); and/or
from 19% to 35% by weight of linoleic acid (C18:2); and/or
from 0% to 4% by weight of linolenic acid (C18:3);
said percentage of acid being based on the total weight of C8 to C24 fatty acids.

19. The fat composition according to claim 1, wherein the fat composition has a percentage of palmitic acid on the second position of triglyceride (SN-2 of C16:0) of from 50% to 80% based on the total palmitic acid.

20. The fat composition according to claim 1, wherein the fat composition comprises:
from 0% to 3.5% by weight of PPP triglycerides; and/or
from 12% to 32% by weight of OPL triglycerides; and/or
from 12% to 32% by weight of OPO triglycerides; and/or
from 5% to 18% by weight of LPL triglycerides;
based on the total glycerides present in the fat composition, wherein P is palmitic acid, O is oleic acid and L is linoleic acid.
